(19) United States
(12) Patent Application Publication
(10) Pub. No.: US 2006/0036817 A1
(43) Pub. Date: Feb. 16, 2006

(54) Method and system for supporting memory unaligned writes in a memory controller

(76) Inventors: Alpesh B. Oza, Sunnyvale, CA (US); Rohit R. Verma, San Jose, CA (US); Sridhar Lakshmanamurthy, Sunnyvale, CA (US)

Correspondence Address: KONRAD RAYNES & VICTOR, LLP, 315 S. BEVERLY DRIVE, # 210, BEVERLY HILLS, CA, 90212, US

(21) Appl. No.: 10/915,751

(22) Filed: Aug. 10, 2004

(51) Int. Cl. G06F 12/00

(52) U.S. Cl. 711/155

(57) ABSTRACT

Provided are a method and system for handling unaligned writes in a memory controller. A first write request to a memory device in a queue is processed. The first write request is sent to a read modify write (RMW) engine in response to determining that the first write request is unaligned with respect to a first memory location in the memory device. A second write request that is aligned with respect to a second memory location in the memory device is processed. A determination is made of whether there is one write request pending in the RMW engine to the second memory location. The second write request is executed in response to determining that there is no write request pending in the RMW engine.

### BACKGROUND

A processor may buffer information in a memory device, such as a Static Random Access Memory (SRAM) through memory channels. A Quad Data Rate (QDR) high bandwidth SRAM supports bursts of two with a minimum four byte access. A reduced latency dynamic random access memory (RLDRAM) provides larger capacity, lower power, and lower cost per bit over QDR SRAM and supports a burst of 4, with a minimum access size of 8 bytes. For RLDRAM, 8 byte memory locations are accessed. In order to be backward compatible with legacy software, the RLDRAM controller may be configured to support writes that are unaligned on an 8 byte boundary. An unaligned write is a write transaction where either the starting address is not aligned with the natural memory alignment or the length of the transaction is not a multiple of the natural memory burst length. The natural memory alignment refers to the offset into the memory at which the processor expects the data i.e., the 8 byte access size, to reside. For instance, for a memory system where the natural memory alignment is on an eight byte boundary and memory burst lengths are multiples of eight bytes, the following writes will be unaligned—writes with lengths of 4 bytes, 12 bytes, 20, bytes, etc., or writes whose starting address is not on an 8 byte boundary, i.e. the last 3 bits of the byte address are non-zero.

### BRIEF DESCRIPTION OF THE DRAWINGS

FIG. 1 illustrates a memory device;

FIGS. 2 and 3 illustrate a memory controller enabled to process read-modify-write operations.

FIGS. 4 and 5 illustrate operations performed by the memory controller to access the memory.

FIG. 6 illustrates a network processor environment.

FIG. 7 is a diagram of a network device.

### DETAILED DESCRIPTION

In the following description, reference is made to the accompanying drawings which form a part hereof and which illustrate several embodiments. It is understood that other embodiments may be utilized and structural and operational changes may be made without departing from the scope of the embodiments.

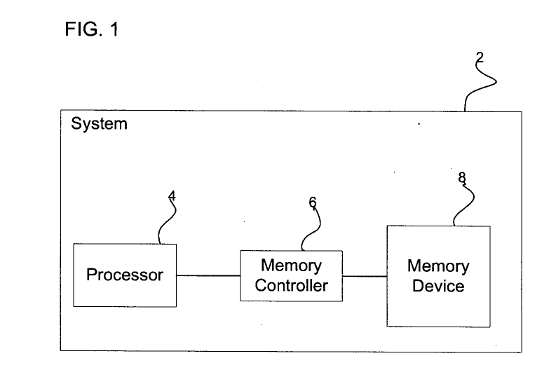

FIG. 1 illustrates a system 2 having a processor 4, such as a central processing unit, a memory controller 6 and one or more external memory devices 8, such as an SRAM, RLDRAM or other memory interfaces known in the art. The memory controller 6 generates signals to control read and write requests from the processor 4 to the memory 8.

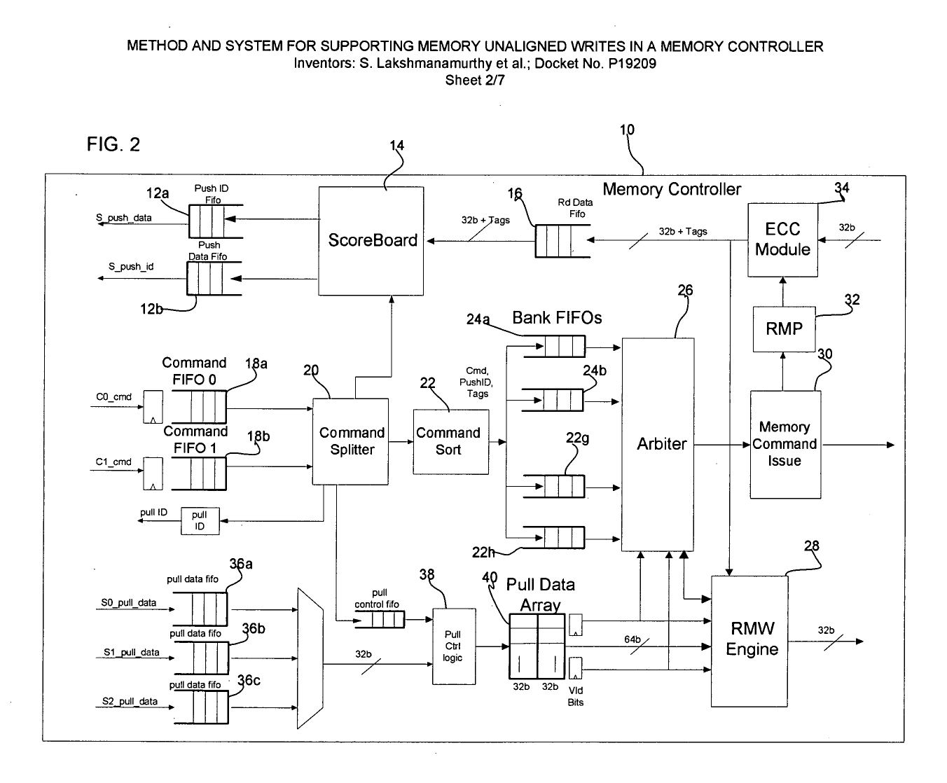

FIG. 2 illustrates an embodiment of a memory controller 10 that controls read and write requests to the memory. Push identifier (ID) 12a and push data 12b First-in-First-Out (FIFO) buffers buffer an identifier and data requested by a processor 4 in a read request. A scoreboard 14 manages the transfer of read data from the read data FIFO 16 to the push FIFOs 12 as, 12b. Command FIFOs 18a, 18b buffer commands received from the processor 4 directed to the memory device 8. A command splitter 20 forwards read and write requests to a command sort 22 that forwards commands to a bank FIFO 24a, 24b . . . . 24n, where n may be eight for eight bank FIFOs. The command splitter 20 may detect unaligned accesses and forward commands for unaligned accesses as address tags to the command sort 22. An unaligned access comprises an access, such as a write, of a number of bytes that is less than the minimum access size supported by the memory device 8. The command splitter 20, upon detecting a write spanning multiple memory locations identified by different tag addresses, may submit the write data in two write requests to the two memory locations. The command splitter 20 submits the address tag of the full memory location including all or part of the unaligned write data.

For instance, for an RLDRAMII, data is accessed in 8 byte segments. To be backward compatible with legacy software that issues 4 byte accesses, the memory controller 10 should support writes that are unaligned on the 8 byte addressable memory locations. In certain embodiments, an unaligned write, including a legacy byte write for less than the minimum access size, results in a read-modify-write (RMW) operation, where the 8 bytes of the full memory location including the data to write are accessed and the accessed 8 byte memory location is updated with the data to write. This updated 8 byte memory block is written to memory 8.

An arbiter 26 processes the commands in the bank FIFOs 24a, 24b . . . 24n. The arbiter 26 comprises a fine state machine (FSM) that accesses commands from the FIFOs 24a, 24b . . . 24n and determines whether to forward the command to the memory command issue 30 logic that executes the command against the memory device 8 or sends the command to a read modify write (RMW) engine 28 to process. The arbiter 26 manages the bank FIFOs 24a, 24b . . . 24n, such as handling bank conflicts and optimizing performance from every bank FIFO 24a, 24b . . . 24n. The read delay matching pipeline (RMP) 32 operates as a simple delay module, such that after a read is issued, the tags associated with the command are sent to the RMP 32 that may delay aligning the tags with the incoming read data. An error checking code (ECC) module 34 checks incoming read data from the memory 8 for ECC corruption. If the data passes the error checking test, then the ECC module 34 forwards the data to the read FIFO 16 to eventually return to the processor 4.

Write data is buffered in the pull data FIFOs 36a, 36b, 36c. The data to write is then transferred by the pull control logic 38 into a pull data array 40. This write data in the pull data array 40 is either forwarded by the arbiter 26 to the memory command issue 30 to write or forwarded to the RMW engine 28 to apply to the read data to perform the read-modify-write operation for the unaligned write. The command splitter 20 upon receiving a write may forward a pull ID 42 to request the data from the processor 4 and forward a pull control FIFO 44 to the pull control logic 38 to use to pull the write data associated with the command the command splitter 20 is processing.

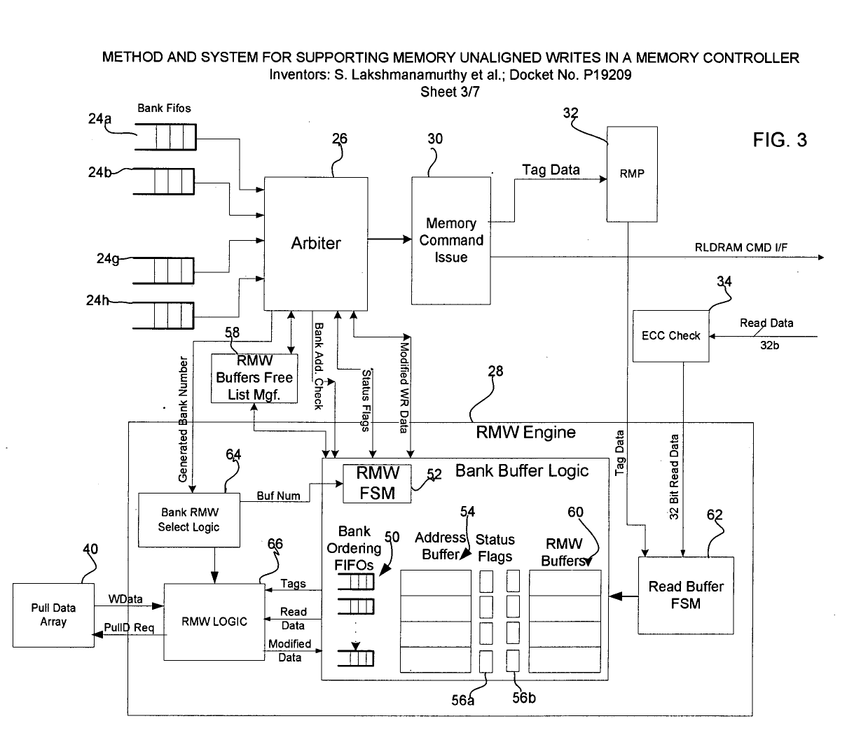

FIG. 3 illustrates further details of an RMW engine 28 in the memory controller 10 shown in FIG. 2, as well as other components, such as the bank FIFOs 24a, 24b, 24h, the arbiter 26, the memory command issue 30, RMP 32, etc. The RMW engine 28 includes components for performing the read modified write operation, such as bank ordering FIFOs 50 to store RMW operations to process, also referred to as offloaded RMW operations. In certain embodiments, there may be one bank ordering FIFO for each bank FIFO 24a, 24b . . . 24g, 24h, such that write requests in one bank FIFO 24a, 24b . . . 24h are queued in a corresponding bank ordering FIFO 50 in the RMW engine 28. An address buffer 54 comprises a content addressable memory having the addresses updated by the RMW operation and status flags 56a indicate whether a corresponding entry in the address buffer 54 is involved in a pending RMW operation. The RMW buffers 60 store the data at the memory location to be updated. Each entry in the buffers 60 has a corresponding status flag 56b indicating whether the corresponding buffer 60 entry has valid data.

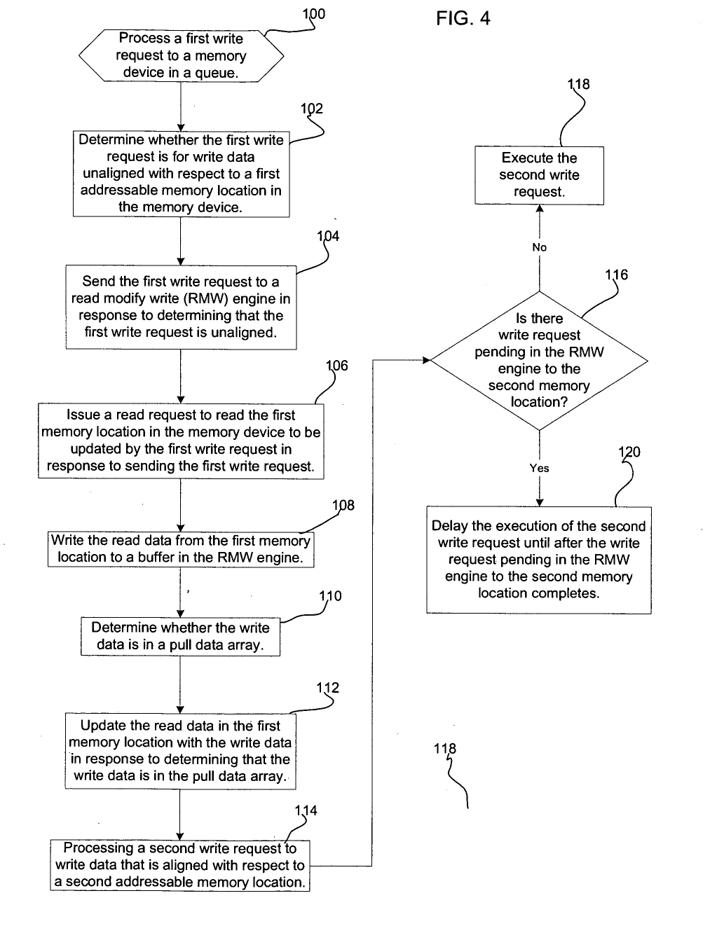

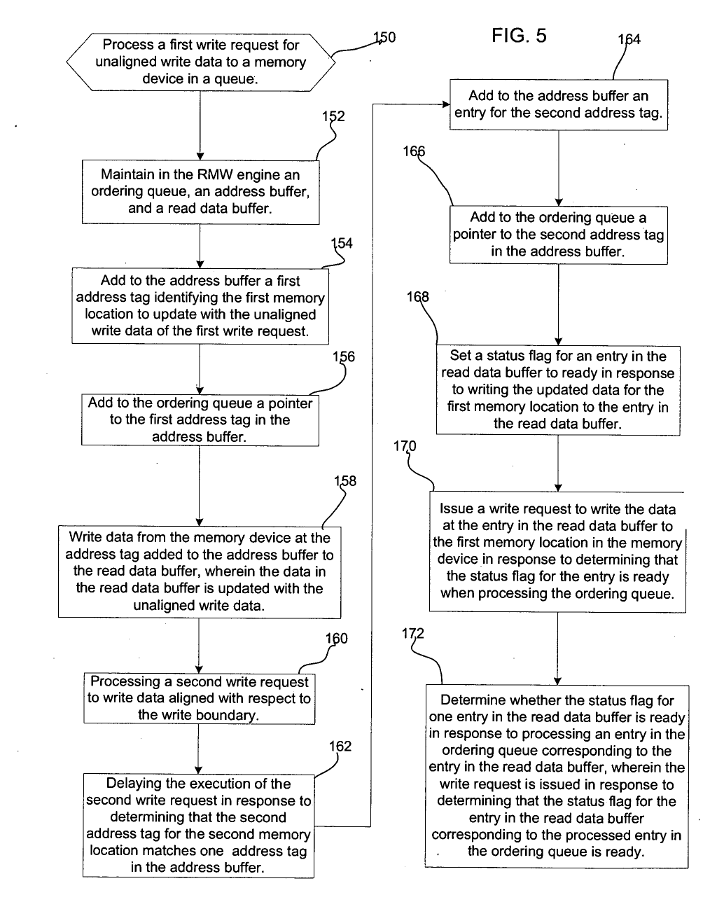

FIGS. 4 and 5 illustrate operations performed by the memory controller 10 components to process I/O requests. With respect to FIG. 4, control begins at block 100 by processing a first write request to a memory device in a queue. With respect to FIGS. 4 and 5, the arbiter 26 processes (at block 100) requests in the bank FIFOs 24a, 24b . . . 24h. The arbiter 26 determines (at block 102) whether the first write request is for write data unaligned with respect to a first memory location in the memory device. For instance, a QDR legacy 4 byte write may be unaligned with respect to an 8 byte addressable memory location, i.e., block of memory, in an RLDRAM device. The arbiter 26 sends (at block 104) the first write request to a read modify write (RMW) engine 28 in response to determining that the first write request is unaligned. The arbiter 26 may send the first RMW request by requesting from the RMW buffers free list manager 58 a free entry in the RMW buffer 60. If there is a free address buffer 54 entry, then the RMW FSM 52 places the address to which the RMW operation writes, i.e., the address tag of the memory block including the unaligned write data for the first write request, in the free address buffer 54 entry. Further, the RMW FSM 52 may queue the entry in the address buffer 54 including the address tag in the bank ordering FIFO 50 corresponding to the bank FIFO 24a, 24b24h from which the first write request was accessed. An unaligned write request may be split into two write requests, where the write data is written to two different memory locations. Further, a status flag 56a for the entry in the address buffer 54 to which the RMW write is directed is set to pending. The address buffer 54 contains the address tags of all current RMW operations being executed in the RMW engine 28.

A read request is issued (at block 106) to read an address tag including the data to be updated by the first write request in response to sending the first write request. For instance, after the RMW buffers free list manager 58 obtains a free RMW buffer 60, the arbiter 26 may submit a read request to the memory command issue 30 to read the block of data at the address tag of the block in the memory device 8 including the unaligned write data. The read data from the first memory location in the memory 6 is written (at block 108) to RMW buffer 60 in the RMW engine 28. After the data at the memory location in the memory 6 is read, the RMP 32 may align the read data with the address tag and then route the data to the read buffer FSM 62, which then stores the data in the RMW buffer 60 at the location specified by the address tag and sets the status flag 56b for the updated entry in the RMW buffer 60 to valid.

A determination is made (at block 110) whether the write data is in a pull data array 40. If so, the read block of data in the buffer is updated with the write data in response to determining that the write data is in the pull data array 40. In certain embodiments, this determination is performed when the bank RMW select logic 64 receives selection of one bank number, i.e., FIFO queue number, and forwards this to the RMW FSM 52. The RMW FSM 52 checks the bank ordering FIFO 50 corresponding to the bank number selected by the RMW select logic 64. The RMW FSM 52 may check the head of the selected bank ordering 50 for pending RMW operations. If there is a pending write operation in the checked bank ordering FIFO 50 having valid status 56a, then the RMW FSWM 52 uses the address tag in the address buffer 54 for the valid entry to determine whether the write data (WData) for that address tag is in the pull data array 40. In certain embodiments, the bank RMW select logic 64 operates in parallel to the read buffer FSM 62, and may track the arbiter 26 operations by operating two cycles ahead of the arbiter 26 logic, such that the RMW select logic 64 processes a FIFO in the bank ordering FIFO 50 that is a fixed number of banks, i.e., cycles of the bank the arbiter 26 is processing. Thus, if the arbiter 26 is servicing FIFO 0, the RMW select logic 64 processes the bank ordering FIFO 2.

If the data is in the pull data array 40, then the read data in the first memory location is updated (at block 112) with the write data. This updating may occur by the RMW FSM 52 forwarding a request to the RMW logic 66 to obtain the requested write data from the pull data array 40. The RMW logic 66 then reads the data for the address from the RMW buffers 60 and merges the read data with the pull data. The RMW logic 66 may also calculate a new ECC for the modified data and writes the modified data back to the entry in the RMW buffer 60 so the read modified write is now in the entry in the RMW buffer 60. The status flag 56b for the updated RMW buffer is then set to ready. If the valid status flag 56a for the entry in the address buffer 54 is not set, then the RMW FSM 52 skips that cycle.

The arbiter 26 may process (at block 114) a second, i.e., subsequent, write request to write data that is aligned with respect to a second addressable memory location, i.e., a memory address in memory device 8. The arbiter 26 determines (at block 116) whether there is a request pending in the RMW engine 28 to the second memory location. For instance, when the arbiter 26 first selects a bank FIFO 24a, 24b . . . 24h, the arbiter 26 checks whether the address tag of the second write request matches an address tag in the address buffer 54 for a pending write request, indicating that the second, i.e., subsequent, write request is to a memory location to which a write request, such as a read modify write request, is pending. If (at block 116) there is no write request pending in the RMW engine 28 to the second memory location, then the second write request is executed (at block 118). For instance, if there is no match, i.e., a miss, then the arbiter 26 sends the write request to the memory command issue 30 to execute. If (at block 116) there is a write request pending in the RMW engine 28 to the second memory location, then the execution of the second write request is delayed (at block 120) until after the write request pending in the RMW engine 28 to the second memory location completes. A write request completes when the data is transmitted out or is written to the target memory location in the memory device to be updated. Completion may or may not require acknowledgment. For instance, there is a match if there is an address tag in the address buffer 54 matching the address tag of the memory location the second write request updates. In certain embodiments, the second write request may be delayed by adding the second write request to the bank ordering FIFO 50 in the RMW engine 28 corresponding to the bank FIFO 24a, 24b . . . 24g from which the second write request was accessed to serialize the second write request with respect to already pending write requests, including read modify write requests, to the same address tag in the RMW engine 28.

FIG. 5 describes an additional embodiment of operations for processing write requests implemented in the components of the memory controller, e.g., 4, 10. Control begins at block 150 by processing a first write request to a memory device in a queue. With respect to FIGS. 2 and 3, the arbiter 26 processes (at block 100) requests in the bank FIFOs 24a, 24b . . . 24g, 24h. The memory controller 10 maintains (at block 152) in the RMW engine 28 an ordering queue, e.g., such as the bank ordering FIFOs 50 (FIG. 3), an address buffer, e.g., 54, and a read data buffer, e.g., RMW buffers 60. A first address tag identifying the first memory location is added (at block 154) to the address buffer, e.g., 54, identifying the first memory location to update with the unaligned write data of the first write request. A pointer to the first address tag in the address buffer, e.g., 54, is added (at 156) to the ordering queue. Further a status flag 56a for the entry in the address buffer 54 updated with the tag address may be set to valid to indicate a pending write request is being processed in the RMW engine 28. Data is written (at block 158) from the memory, e.g., 8, at the location of the address tag added to the address buffer, e.g., 54, to the read data buffer, e.g., RMW buffers 60, wherein the data in the read data buffer, e.g., 56, is updated with the unaligned write data. The arbiter 26 may issue a command to the memory command issue 26 to access the data at the address tag in the memory 8 to write to the RMW buffers 60 via the read buffer FSM 62.

A second write request to write data that is aligned with respect to the write boundary may be processed (at block 160) independently of offloaded read modify writes to different memory locations. The execution of the second write request is delayed (at block 162) in response to determining that a second address tag for the second memory location matches one address tag in the address buffer. The arbiter 26 may determine whether the memory location to which the second write request is directed matches an address tag in the address buffer 54. In certain embodiments, the address buffer 54 comprises a content addressable memory whose contents may be searched. The second write request may be delayed by adding (at block 164) to the address buffer, e.g., 54, an entry for the second address tag and adding (at block 166) to the ordering queue, e.g., 50, a pointer to the second address tag in the address buffer, e.g., 54. In this way, the second write request is serialized and processed after completing write requests in the RMW engine 28 that precede the second write request. The only difference is that the pull data merged with the read memory location comprises data for the entire memory location, not just a portion thereof as is the case with an unaligned write.

A status flag, e.g., 56b, for an entry in the read data buffer is set (at block 168) to ready in response to writing the updated data for the first memory location to the entry in the read data buffer, e.g., 60, indicating that the read data buffer may be updated with the write data, which may be accessed through the pull data array 40. A write request is issued (at block 170) to write the data at the entry in the read data buffer to the first memory location in the memory device in response to determining that the status flag, e.g., 56, for the entry in the data buffers 60 is ready when processing the ordering queue, 50. For instance, when the arbiter 26 selects a bank FIFO 24a, 24b . . . 24h, it checks the corresponding bank ordering FIFO 50 entries for one entry corresponding to an entry in the RMW buffers 60 that has the ready status flag set. If the ready flag is set, then the arbiter 26 issues a write request to write the data in the RMW buffers that has ready status. The arbiter 26 may further dequeue the written RMW buffers 60 to the RMW buffer free list manager 58 to reuse and dequeue the entry number for this read modify write operation from the bank ordering FIFO 50. The arbiter 26 issues (at block 170) a write request to write the data at the entry in the read data buffer, e.g., 60, to the memory din response to determining that the status flag 56b for the entry is ready when processing the ordering queue, e.g., 50. A determination is made (at block 172) as to whether the status flag, e.g., 56b, for one entry in the read data buffer, e.g., 60, is ready in response to processing an entry in the ordering queue, e.g., 50, corresponding to the entry in the read data buffer 60. The write request is issued in response to determining that the status flag 56b for the entry in the read data buffer corresponding to the processed entry in the ordering queue is ready.

Described embodiments provide techniques to process read-modify-write operations for unaligned writes in a manner that does not delay other queued write requests to different address tags by sending or offloading the read-modify-write operations to a RMW engine. After the RMW operation is sent, i.e., offloaded, to the RMW engine, subsequent queued write requests to memory locations different than those subject to pending write requests in the RMW engine may immediately be executed without having to wait for the RMW operation to complete. This improves performance and reduces latency because RMW operations take longer than simple aligned write operations. If a write request is to an address location matching an address tag of a pending RMW operation, then that write request is delayed to complete after the RMW operation to the same memory location completes.

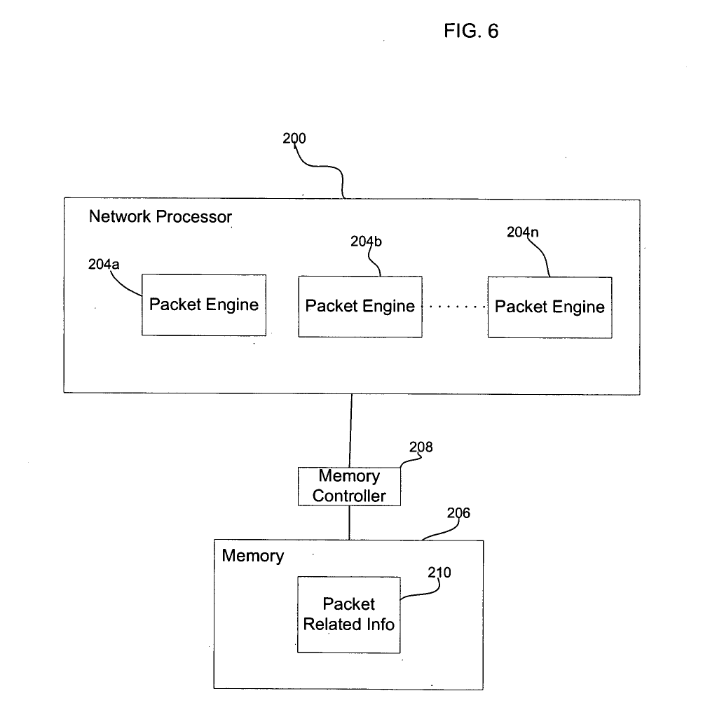

FIG. 6 illustrates an embodiment using the memory controller described above within a network processor. A network processor comprises any device that executes programs to handle packets in a data network, such as processors on router line cards, network access equipment and packet forwarding devices. Network processor 200 includes packet engines 204a, 204b . . . 204n comprising high speed processors specialized for packet processing. The packet engines may comprise any programmable engine or processor for processing packets, such as a microengine, etc. The packet engines 204a, 204b . . . 204n may execute program logic, such as microblocks, to process packets, where a microblock comprises fast-path packet processing logic executed by the packet engines 204a, 204b . . . 204n. The network processor packet engines 204a, 204b . . . 204n access a memory 206 via a memory controller 208 to access packet related information 210, which includes the packet data or information used to manage the packets, such as packet queues and packet descriptors. The packet data and packet management information may be maintained in separate memory devices. For instance, when a packet is added to the packet memory, an entry, referred to as a buffer descriptor, is added to a packet queue in another memory device, such as a Static Random Access Memory (SRAM) accessed through memory controller 208, which is used to maintain information on the packets added to the packet memory, e.g., an SDRAM. The packet information may further include a queue descriptor including information on a packet queue of buffer descriptors, including a head and tail pointers and queue count of the number of buffer descriptors in the queue. The SRAM may include multiple queues for packets in the SDRAM.

The memory 206 may comprise an RLDRAMIII high bandwidth SRAM. The memory controller 208, which may include the memory controller components and operability described above with respect to FIGS. 2, 3, 4, and 5, may be used to manage packet queue information.

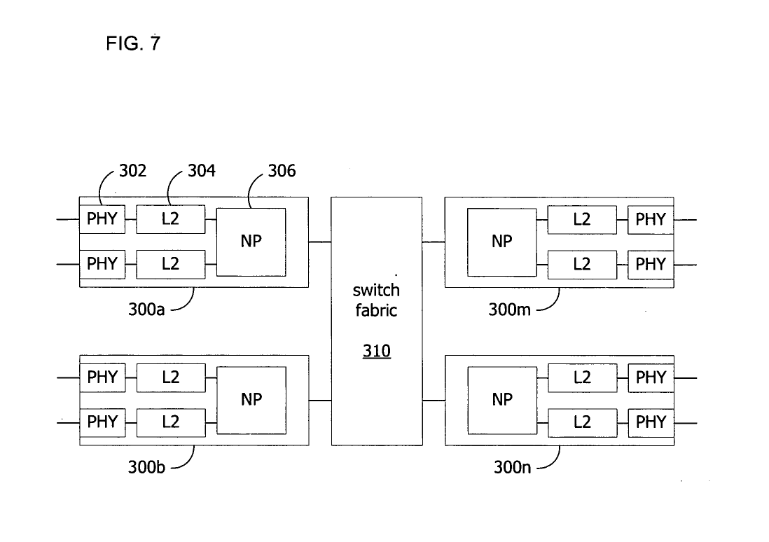

FIG. 7 depicts a network device incorporating the network processor and memory controller described above. As shown, the device features a collection of line cards 300 (“blades”) interconnected by a switch fabric 310 (e.g., a crossbar or shared memory switch fabric). The switch fabric, for example, may conform to CSIX or other fabric technologies such as HyperTransport, Infiniband, PCI-X, Packet-Over-Synchronous Optical Network (SONET), RapidIO, and Utopia. CSIX is described in the publication “CSIX-L1: Common Switch Interface Specification-L1”, Version 1.0, published August, 2000 by CSIX; HyperTransport is described in the publication “HyperTransport I/O Link Specification”, Rev. 1.03, published by the HyperTransport Tech. Consort., October, 2001; InfiniBand is described in the publication “InfiniBand Architecture, Specification Volume 1”, Release 1.1, published by the InfiniBand trade association, November 2002; PCI-X is described in the publication PCI-X 2.0 Specification by PCI-SIG; SONET is described in the publication “Synchronous Optical Network (SONET)—Basic Description including Multiplex Structure, Rates and Formats,” document no. T1X1.5 by ANSI (January 2001); RapidIO is described in the publication “RapidIO Interconnect Specification”, Rev. 1.2, published by RapidIO Trade Ass'n, June 2002; and Utopia is described in the publication “UTOPIA: Specification Level 1, Version 2.01”, published by the ATM Forum Tech. Comm., March, 1994.

Individual line cards (e.g., 300a) include one or more physical layer (PHY) devices 302 (e.g., optic, wire, and wireless PHYs) that handle communication over network connections. The PHYs translate between the physical signals carried by different network mediums and the bits (e.g., “0”-s and “1”-s) used by digital systems. The line cards 300 may also include framer devices (e.g., Ethernet, Synchronous Optic Network (SONET), High-Level Data Link (HDLC) framers or other “layer 2” devices) 304 that can perform operations on frames such as error detection and/or correction. The line cards 300 shown also include one or more network processors 306 or integrated circuits (e.g., ASICs) that perform packet processing operations for packets received via the PHY(s) 300 and direct the packets, via the switch fabric 310, to a line card providing the selected egress interface. Potentially, the network processor(s) 306 may perform “layer 2” duties instead of the framer devices 304 and the network processor operations described herein. The network processors 306 may have the configuration of network processor 200 (FIG. 6) using memory 206 and memory controller 208.

### Additional Embodiment Details

The described embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.), computer accessible medium, or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the embodiments, and that the article of manufacture may comprise any information bearing medium known in the art.

The described operations may be performed by circuitry, where “circuitry” refers to either hardware or software or a combination thereof. The circuitry for performing the operations of the described embodiments may comprise a hardware device, such as an integrated circuit chip, Programmable Gate Array (PGA), Application Specific Integrated Circuit (ASIC), etc. The circuitry may also comprise a processor component, such as an integrated circuit, and code in a computer readable medium, such as memory, wherein the code is executed by the processor to perform the operations of the described embodiments.

In the described embodiments, the memory controller used the RMW engine to process unaligned writes with respect to the minimum access size and block boundaries in the memory device. Such writes may be from legacy software. In additional embodiments, the RMW engine may be used to process other types of write operations.

The described embodiments showed certain components within the memory controller and RMW engine to perform certain operations. In alternative embodiments, certain of the described operations may be performed by different components than those shown in FIGS. 2 and 3.

In certain embodiments, the memory controller of the described embodiments may be used with a network processor having multiple packet engines that access the memory through the memory controller. In alternative embodiments, the memory controller of the described embodiments may receive requests from computing devices other than network processing units, such as one or more central processing units in a computer workstation, desktop, laptop, hand held system, server, I/O controller, storage controller, etc.

The term packet is sometimes used in the above description to refer to a packet conforming to a network communication protocol. However, a packet may also be a frame, fragment, ATM cell, and so forth, depending on the network technology being used. Alternatively, a packet may refer to a unit of data transferred from devices other than network devices, such as storage controllers, printer controllers, etc.

The illustrated operations of FIGS. 4 and 5 show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to limit the embodiments to the precise form disclosed. Many modifications and variations are possible in light of the above teaching.

What is claimed is:

1. A method, comprising:
processing a first write request to a memory device in a queue;
sending the first write request to a read modify write (RMW) engine in response to determining that the first write request is unaligned with respect to a first memory location in the memory device;
processing a second write request that is aligned with respect to a second memory location in the memory device;
determining whether there is at least one write request pending in the RMW engine to the second memory location; and
executing the second write request in response to determining that there is no write request pending in the RMW engine.

2. The method of claim 1, further comprising:
delaying the execution of the second write request in response to determining that there is a write request pending in the RMW engine to the second memory location until after the write request pending in the RMW engine to the second memory location completes.

3. The method of claim 1, further comprising:
issuing a read request to read the first memory location in the memory device to be updated by the first write request in response to sending the first write request; and
updating, in the RMW engine, the read data in the first memory location with the write data, wherein the updated data first memory location comprises a read-modified-write that is written to the memory device.

4. The method of claim 3, further comprising:
writing the read data in the first memory location to a buffer in the RMW engine;
determining whether the write data is in a pull data array, wherein updating the read data from the first memory location with the write data comprises updating the write data in the buffer in response to determining that the write data is in the pull data array.

5. The method of claim 4, further comprising:
storing sent requests in a queue; and
receiving selection of one write request entry in the queue, wherein determining whether the write data is in the pull data array comprises determining whether the write data for the selected write request entry in the queue is in the pull data array.

6. The method of claim 5, wherein the selection of one write request is received from select logic operating in parallel to logic issuing the read request.

7. The method of claim 6, wherein the select logic operates a fixed number of cycles ahead of the logic issuing the read request.

8. The method of claim 1, wherein the first write request is for unaligned write data and wherein sending the first write request to the RMW engine further comprises:
maintaining in the RMW engine an ordering queue, an address buffer, and a read data buffer;
adding to the address buffer a first address tag identifying the first memory location in the memory device to update with the unaligned write data;
adding to the ordering queue a pointer to the first address tag in the address buffer; and
writing data from the memory device at the first memory location to the read data buffer, wherein the data in the read data buffer is updated with the unaligned write data.

9. The method of claim 8, further comprising:
delaying the execution of the second write request in response to determining that a second address tag for the second memory location matches one address tag in the address buffer.

10. The method of claim 9, wherein delaying the execution of the second write request comprises:
adding to the address buffer an entry for the second address tag; and
adding to the ordering queue a pointer to the second address tag in the address buffer.

11. The method of claim 8, further comprising:
setting a status flag for an entry in the read data buffer to ready in response to writing the updated data for the first memory location to the entry in the read data buffer; and
issuing a write request to write the data at the entry in the read data buffer to the first memory location in the memory device in response to determining that the status flag for the entry is ready when processing the ordering queue.

12. The method of claim 11, further comprising:
determining whether the status flag for one entry in the read data buffer is ready in response to processing an entry in the ordering queue corresponding to the entry in the read data buffer, wherein the write request is issued in response to determining that the status flag for the entry in the read data buffer corresponding to the processed entry in the ordering queue is ready.

13. The method of claim 1, wherein the write data for the write request is to update an amount of data less than a minimum access size for the memory device.

14. A memory system, comprising:
a memory device storing data at memory locations identified by address tags;
a memory controller coupled to the memory device and including:
(i) a queue in which data requests are added;
(ii) a read modify write (RMW) engine;
(iii) logic enabled to perform:
(a) processing a first write request in the queue;
(b) sending the first write request to a read modify write (RMW) engine in response to determining that the first write request is unaligned with respect to a first memory location in the memory device;
(c) processing a second write request that is aligned with respect to a second memory location in the memory device;
(d) determining whether there is at least one write request pending in the RMW engine to the second memory location; and
(e) executing the second write request in response to determining that there is no write request pending in the RMW engine.

15. The memory system of claim 14, wherein the logic is further enabled to perform:
delay the execution of the second write request in response to determining that there is a write request pending in the RMW engine to the second memory location until after the write request pending in the RMW engine to the second memory location completes.

16. The memory system of claim 14, wherein the logic is further enabled to perform:
issue a read request to read the first memory location in the memory device to be updated by the first write request in response to sending the first write request; and
update, in the RMW engine, the read data in the first memory location with the write data, wherein the updated data first memory location comprises a read-modified-write that is written to the memory device.

17. The memory system of claim 16, further comprising:
a buffer in the RMW engine;
a pull data array;
wherein the logic is further enabled to perform:
(i) write the read data in the first memory location to a buffer in the RMW engine;
(ii) determine whether the write data is in a pull data array, wherein updating the read data from the first memory location with the write data comprises updating the write data in the buffer in response to determining that the write data is in the pull data array.

18. The memory system of claim 17, further comprising:
a queue;
wherein the logic is further enabled to:
(i) store sent requests in the queue; and
(ii) receiving selection of one write request entry in the queue, wherein determining whether the write data is in the pull data array comprises determining whether the write data for the selected write request entry in the queue is in the pull data array.

19. The memory system of claim 18, wherein the selection of one write request is received from select logic operating in parallel to logic issuing the read request.

20. The memory system of claim 19, wherein the select logic operates a fixed number of cycles ahead of the logic issuing the read request.

21. The memory system of claim 16, further comprising:
a buffer in the RMW engine;
a pull data array;
wherein the logic is further enabled to perform:
(i) write the read data in the first memory location to the buffer;
(ii) determine whether the write data is in the pull data array;
(iii) update the read data from the first memory location in the buffer with the write data in response to determining that the write data is in the pull data array.

22. The memory system of claim 14, wherein the first write request is for unaligned write data, further comprising:
an ordering queue in the RMW engine;
an address buffer in the RMW engine; and
a read data buffer in the RMW engine;
wherein the logic sending the first write request to the RMW engine is further enabled to:
(i) add to the address buffer a first address tag identifying the first memory location in the memory device to update with the unaligned write data;
(ii) add to the ordering queue a pointer to the first address tag in the address buffer; and
(iii) write data from the memory device at the first memory location to the read data buffer, wherein the data in the read data buffer is updated with the unaligned write data.

23. The memory system of claim 22, wherein the first write request is for unaligned write data, and wherein the logic is further enabled to:
delay the execution of the second write request in response to determining that a second address tag for the second memory location matches one address tag in the address buffer.

24. The memory system of claim 23, wherein the logic for delaying the execution of the second write request is further enabled to:
add to the address buffer an entry for the second address tag; and
add to the ordering queue a pointer to the second address tag in the address buffer.

25. The memory system of claim 22, further comprising:
a status flag for an entry in the read data buffer;
wherein the logic is further enabled to:
(i) setting the status flag for an entry in the read data buffer to ready in response to writing the updated data for the first memory location to the entry in the read data buffer; and
(ii) issuing a write request to write the data at the entry in the read data buffer to the first memory location in the memory device in response to determining that the status flag for the entry is ready when processing the ordering queue.

26. The memory system of claim 25, wherein the logic is further enabled to perform:
determine whether the status flag for one entry in the read data buffer is ready in response to processing an entry in the ordering queue corresponding to the entry in the read data buffer, wherein the write request is issued in response to determining that the status flag for the entry in the read data buffer corresponding to the processed entry in the ordering queue is ready.

27. The memory system of claim 14, wherein the write data for the write request is to update an amount of data less than a minimum access size for the memory device.

28. A network processor, comprising:
a plurality of packet engines for processing packets; and
a memory system in communication with at least one packet engine, comprising:
(a) a memory device storing data at memory locations identified by address tags;
(b) a memory controller coupled to the memory device and including:
(i) a queue in which data requests are added;
(ii) a read modify write (RMW) engine;
(iii) logic enabled to perform:
(a) processing a first write request in the queue;
(b) sending the first write request to a read modify write (RMW) engine in response to determining that the first write request is unaligned with respect to a first memory location in the memory device;
(c) processing a second write request that is aligned with respect to a second memory location in the memory device;
(d) determining whether there is at least one write request pending in the RMW engine to the second memory location; and
(e) executing the second write request in response to determining that there is no write request pending in the RMW engine.

29. The network processor of claim 28, wherein the memory controller logic is further enabled to perform:
delaying the execution of the second write request in response to determining that there is a write request pending in the RMW engine to the second memory location until after the write request pending in the RMW engine to the second memory location completes.

30. The network processor of claim 28, wherein the logic is further enabled to perform:
issuing a read request to read the first memory location in the memory device to be updated by the first write request in response to sending the first write request; and
updating, in the RMW engine, the read data in the first memory location with the write data, wherein the updated data first memory location comprises a read-modified-write that is written to the memory device.

31. The network processor of claim 28, wherein packet management information used to manage the processing of the packets is maintained in the memory device.

32. A system, comprising:
a switch fabric; and
a plurality of line cards coupled to the switch fabric, wherein each line card includes a network processor, wherein at least one network processor on the line cards includes:
(i) a plurality of packet engines for processing packets; and
(ii) a memory system in communication with at least one packet engine, comprising:
(a) a memory device storing data at memory locations identified by address tags;
(b) a memory controller coupled to the memory device and including:
(i) a queue in which data requests are added;
(ii) a read modify write (RMW) engine;
(iii) logic enabled to perform:
(a) processing a first write request in the queue;
(b) sending the first write request to a read modify write (RMW) engine in response to determining that the first write request is unaligned with respect to a first memory location in the memory device;
(c) processing a second write request that is aligned with respect to a second memory location in the memory device;
(d) determining whether there is at least one write request pending in the RMW engine to the second memory location; and
(e) executing the second write request in response to determining that there is no write request pending in the RMW engine.

33. The system of claim 32, wherein the memory controller logic is further enabled to perform:
delaying the execution of the second write request in response to determining that there is a write request pending in the RMW engine to the second memory location until after the write request pending in the RMW engine to the second memory location completes.

34. The system 32, wherein the logic is further enabled to perform:
issuing a read request to read the first memory location in the memory device to be updated by the first write request in response to sending the first write request; and
updating, in the RMW engine, the read data in the first memory location with the write data, wherein the updated data first memory location comprises a read-modified-write that is written to the memory device.
